(19) United States
(12) Patent Application Publication
(10) Pub. No.: US 2023/0227114 A1
(43) Pub. Date: Jul. 20, 2023

(54) Accessory Track Deck Assembly

(71) Applicant: Leer Group, Elkhart, IN (US)

(72) Inventors: Eugene A. Dylewski, II, Granger, IN (US); Michael A. Sislo, Dexter, MI (US)

(21) Appl. No.: 18/096,966

(22) Filed: Jan. 13, 2023

Related U.S. Application Data
(60) Provisional application No. 63/300,791, filed on Jan. 19, 2022.

(51) Int. Cl. B62D 33/08; B62D 33/02

(52) U.S. Cl. CPC B62D 33/08; B62D 33/02

(57) ABSTRACT

An accessory track deck for use on a truck cargo box is provided. This accessory track deck includes a deck assembly that has at least one plank and at least one accessory track. The at least one accessory track includes an opening, a track channel located adjacent the opening, and at least one rail located adjacent one side of the opening.

### RELATED APPLICATIONS

The present Application relates to and claims priority to U.S. Provisional Patent Application, Ser. No. 63/300791, filed on Jan. 19, 2022. The subject matter disclosed in that Provisional Application is hereby expressly incorporated into the present Application.

### TECHNICAL FIELD AND SUMMARY

The present disclosure is related to bedslides and bed decks for use in pickup truck cargo boxes, and particularly to an accessory track deck for use on such bedslides and bed decks.

Bedslides are movable decks that attach to pickup truck cargo boxes. Typically the bedslide can be moved in and out of the cargo box over the tailgate. With at least a portion of the bedslide'deck covering the floor of the cargo box, items can be placed or removed on the bedslide deck when extended from the cargo box. The bedslide may then be pushed back into the cargo box for the items to be stowed therein.

An illustrative embodiment of the present disclosure provides an accessory track deck for use on a truck cargo box. The accessory track deck comprises a deck assembly that includes: at least one longitudinally extending plank; at least one longitudinally extending accessory track; wherein the at least one longitudinally extending accessory track includes a longitudinally extending opening, a track channel located adjacent the longitudinally extending opening, a first rail located adjacent one side of the longitudinally extending opening, a second rail located adjacent an opposed side of the longitudinally extending opening, and at least one plank channel that receives a portion of the at least one longitudinally extending plank. At least one slider that includes a first rail channel, a second rail channel, and a spring that biases the at least one slider towards the first rail and the second rail of the at least one longitudinally extending accessory track. The first rail channel of the at least one slider receives and is positionable along the first rail. The second rail channel of the at least one slider receives and is positionable along the second rail. And the at least one slider includes an attachment point.

In the above and other illustrative embodiments, the accessory track deck may further comprise: a plurality of longitudinally extending planks; a plurality of longitudinally extending accessory tracks; each of the plurality of longitudinally extending accessory tracks includes a second plank channel that receives a portion of another longitudinally extending plank of the plurality of longitudinally extending planks; the at least one slider is a plurality of sliders; the at least one slider is a plurality of sliders and each of the plurality of sliders is configured to be positionable along one of the plurality of longitudinally extending tracks; a bedslide assembly frame attachable to the truck cargo box, wherein the deck assembly is movable relative to the bedslide assembly frame; a partition, a portion of which is, attachable to the at least one slider; and the attachment point on the at least one slider is selected from the group consisting of at least one of a knob, a footman loop, a hook, a bolt, a tie down, and post.

Another illustrative embodiment of the present disclosure provides an accessory track deck for use on a truck cargo box. This accessory track deck comprises a deck assembly that includes: at least one plank and at least one accessory track; wherein the at least one accessory track includes an opening, a track channel located adjacent the opening, at least one rail located adjacent one side of the opening.

In the above and other illustrative embodiments, the accessory track deck may further comprise: the at least one accessory track includes a second rail located adjacent an opposed side of the opening the at least one accessory track includes at least one plank channel that receives a portion of the at least one plank; at least one slider that includes at least one rail channel, and a spring that biases the at least one slider towards the at least one rail of the accessory track, wherein the at least one rail channel of the at least one slider receives and is positionable along the at least one rail; the at least one slider includes an attachment point that is selected from the group consisting of at least one of a knob, a footman loop, a hook, a bolt, a tie down, nut bore, and post; the at least one accessory track is configured to receive at least one securement structure selected from the group consisting at least one of a nut, a slider, a stud, and a roller, that is movable within the at least one accessory track; and an accessory track cap that includes at least one downward depending leg positionable within the track channel, and wherein the accessory track cap covers the opening of the at least one accessory track.

Another illustrative embodiment of the present disclosure provides an accessory track deck for use on a truck cargo box. This accessory track deck comprises a deck assembly that includes a plurality of accessory tracks; wherein each one of the plurality of accessory tracks includes a longitudinally extending opening, a track channel located adjacent the longitudinally extending opening, a first rail located adjacent one side of the longitudinally extending opening, and a second rail located adjacent an opposed side of the longitudinally extending opening.

In the above and other illustrative embodiments, the accessory track deck may further comprise: the deck assembly further includes at least one plank located adjacent at least one of the plurality of accessory tracks, and wherein at least one of the plurality of accessory tracks includes at least one plank channel that receives a portion of the at least one plank; at least one slider that includes a first rail channel and a second rail channel, and a spring that biases the at least one slider towards the first rail and the second rail of the longitudinally extending accessory track, wherein the first rail channel of the at least one slider receives and is positionable along the first rail, and wherein the second rail channel of the at least one slider receives and is positionable along the second rail; and the at least one of the plurality of accessory tracks is configured to receive at least one securement structure selected from the group consisting at least one of a nut, a slider, a stud, and a roller, that is movable within the at least one of the plurality of accessory tracks.

Additional features and advantages of accessory track deck assembly will become apparent to those skilled in the art upon consideration of the following detailed descriptions of carrying out the accessory track deck assembly as presently perceived.

### BRIEF DISCLOSURE OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a cargo box with its tailgate lowered to an open position and a bed slide;

FIG. 2 is a is a perspective view of cargo box with the bed slide moved outward;

FIG. 3 is a detail perspective view of a portion of an accessory track with an illustrative block secured thereto;

FIG. 4 is a detail perspective view of portion of the accessory track deck;

FIG. 5 is another detail perspective view of a portion of the accessory track deck;

FIG. 6 is another detail perspective view of a portion of the accessory track deck;

FIG. 7 is a side detail view of a portion of the accessory track deck;

FIG. 8 is a perspective view of the cargo box with an accessory track deck installed therein;

FIG. 9 is another perspective view of the cargo box with an accessory track deck installed therein;

FIG. 10 is another perspective view of the cargo box with an accessory track deck installed therein;

FIG. 11 is a top view of a cargo box with an accessory track deck installed therein;

FIG. 12 is a perspective detail view of a portion of the cargo box;

FIG. 13 is a perspective detail view of a portion of the cargo box;

FIG. 14 is a perspective view of the rear deck bracket;

FIG. 15 is a perspective view of the side deck brackets;

FIG. 16 is a perspective view of the cargo box with an accessory track deck having partitions installed thereon;

FIG. 17 is a perspective view of the accessory track with the partitions installed thereon;

FIG. 18 is a detail perspective view of a portion of the accessory track deck with a partition thereon;

FIG. 19 is a detail perspective view of a portion of the accessory track deck with a partition secured thereon;

FIG. 20 is a perspective view of a cargo box with an accessory track deck located

thereon;

FIG. 21 is a perspective view of an accessory track deck;

FIG. 22 is a perspective rear view of a cargo box with an accessory track deck installed thereon and with a slide out assembly attached to the accessory track deck;

FIG. 23 is another perspective rear view of a cargo box with an accessory track deck installed thereon and with a slide out assembly attached to accessory track deck; and

FIG. 24 is a perspective detail view of a portion of the accessory track deck with a track cap installed on the accessory track.

Corresponding reference characters indicate corresponding parts throughout the several views. The exemplification set out herein illustrates embodiments of accessory track deck assembly problem, and such exemplification is not to be construed as limiting the scope of the accessory track deck assembly in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

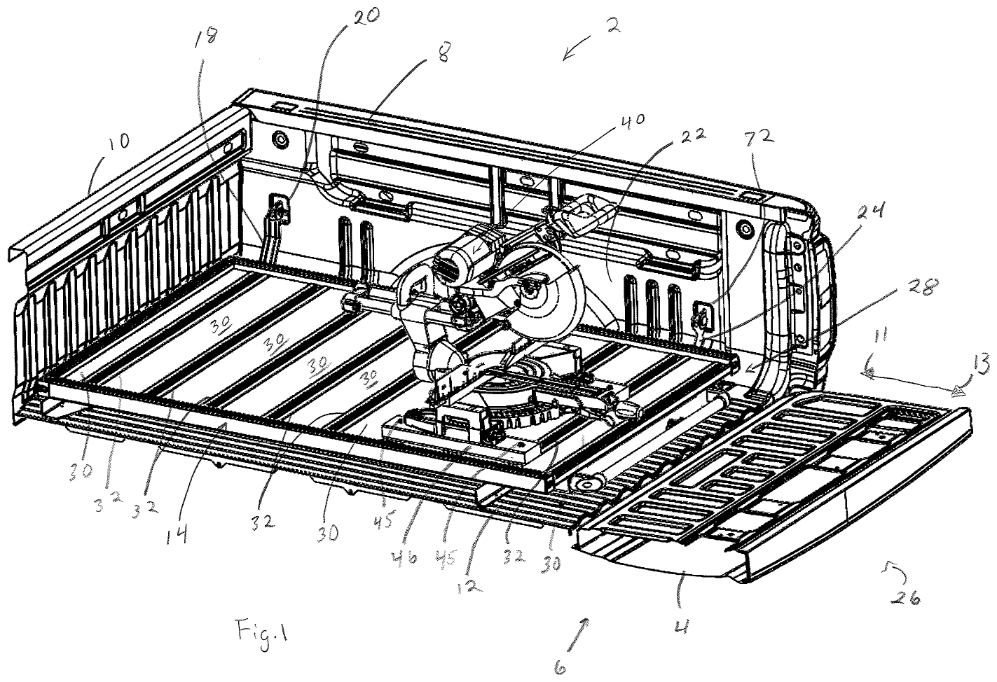

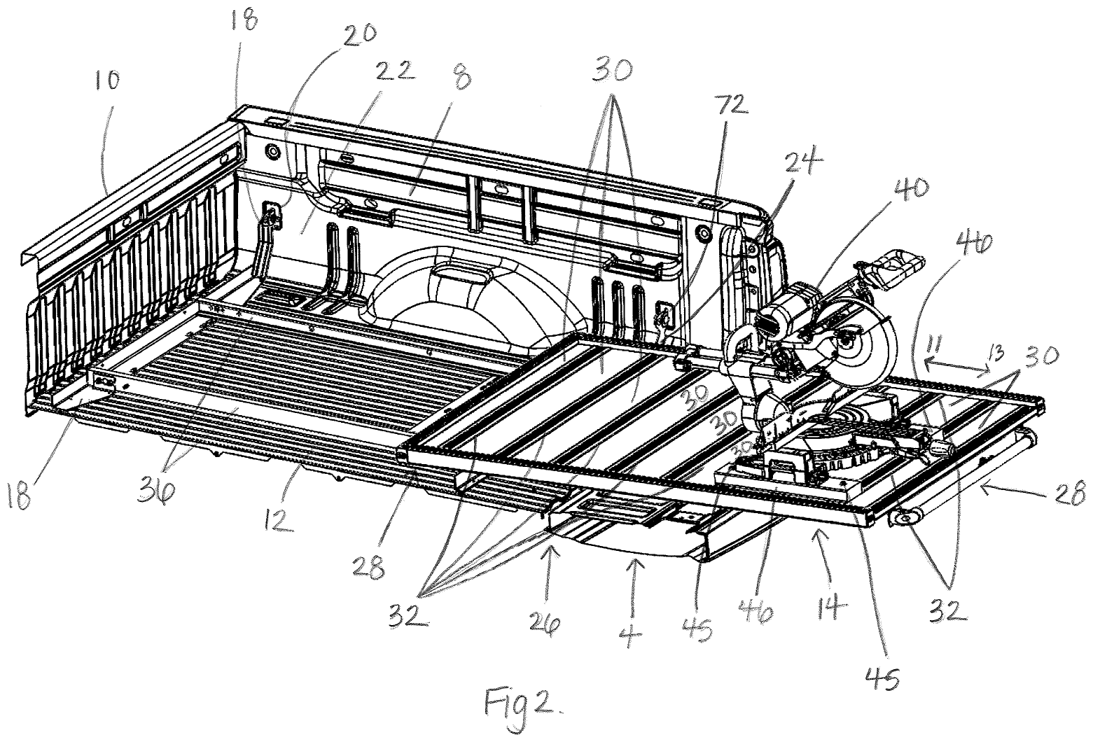

A perspective view of a cargo box 2, with its tailgate 4 lowered to an open position 6, is shown in FIG. 1. Also shown is cargo box sidewall 8 and bulkhead 10 located opposite tailgate 4 on bed floor 12 of cargo box 2. An accessory track deck 14 is shown configured to extended in direction 13 from cargo box 2 (see, FIG. 2), or retract 11 into cargo box 2, as shown here in FIG. 1. Accessory track deck 14 of bedslide 28 may be secured in cargo box 2 via bedslide brackets that attach thereto. For example, a rear bedslide bracket 18 may attach to a rear attachment point 20 already located on inner sidewall portion 22 of cargo box 2. Similarly, side brackets 24 may attach towards the front area of bedslide 28, which is located toward the rear or tailgate end 26 of cargo box 2, to further secure bedslide 28 therein. It will be appreciated that the brackets used for disclosed bedslide 28 and/or accessory track deck 14 may attach to attachment points already formed on sidewalls 8 and 9 and/or bed floor 12 of cargo box 2 or could be attached to newly made attachment points in cargo box 2.

An illustrative embodiment of the present disclosure provides an accessory track deck 14 for use on a bedslide 28 or fixed to cargo box 2 itself. This accessory track deck 14 may be composed of a combination of planks 30 and accessory tracks 32. Planks 30 provide a support surface on accessory track deck 14, while the accessory tracks 32 provide a mechanism for securing structures to accessory track deck 14.

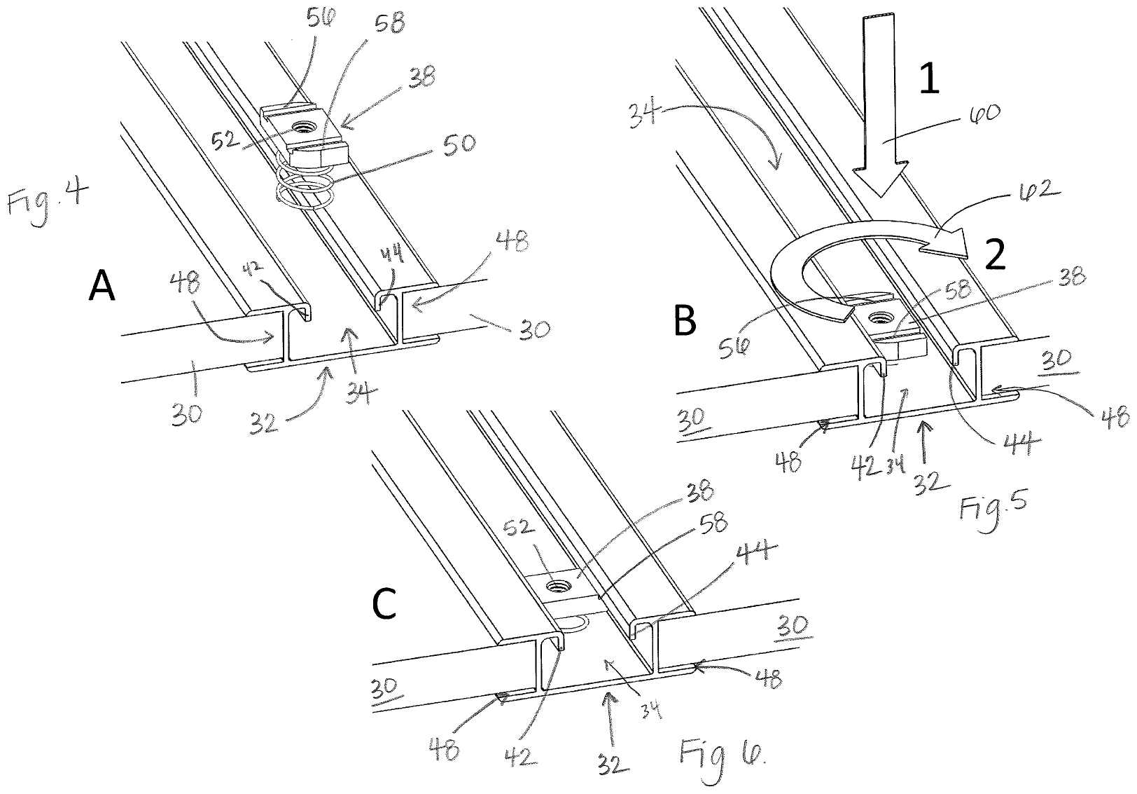

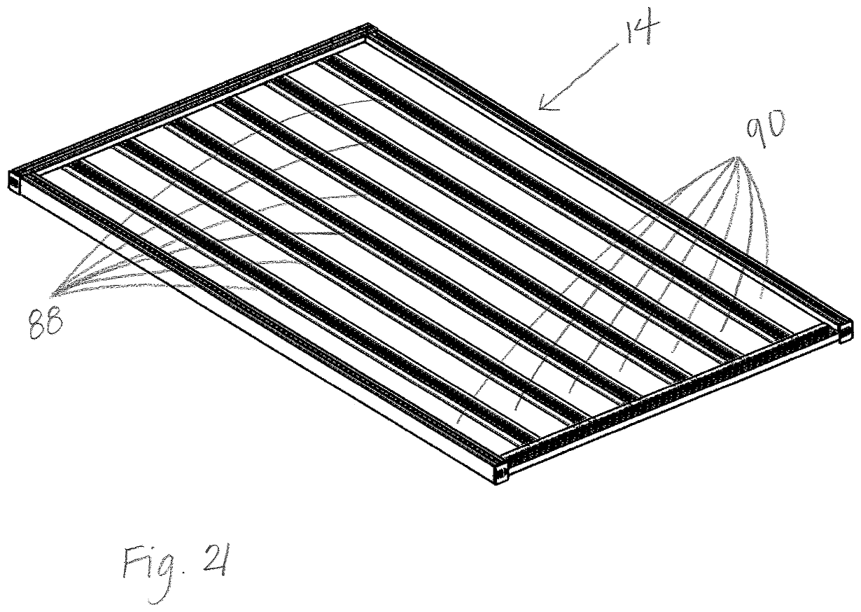

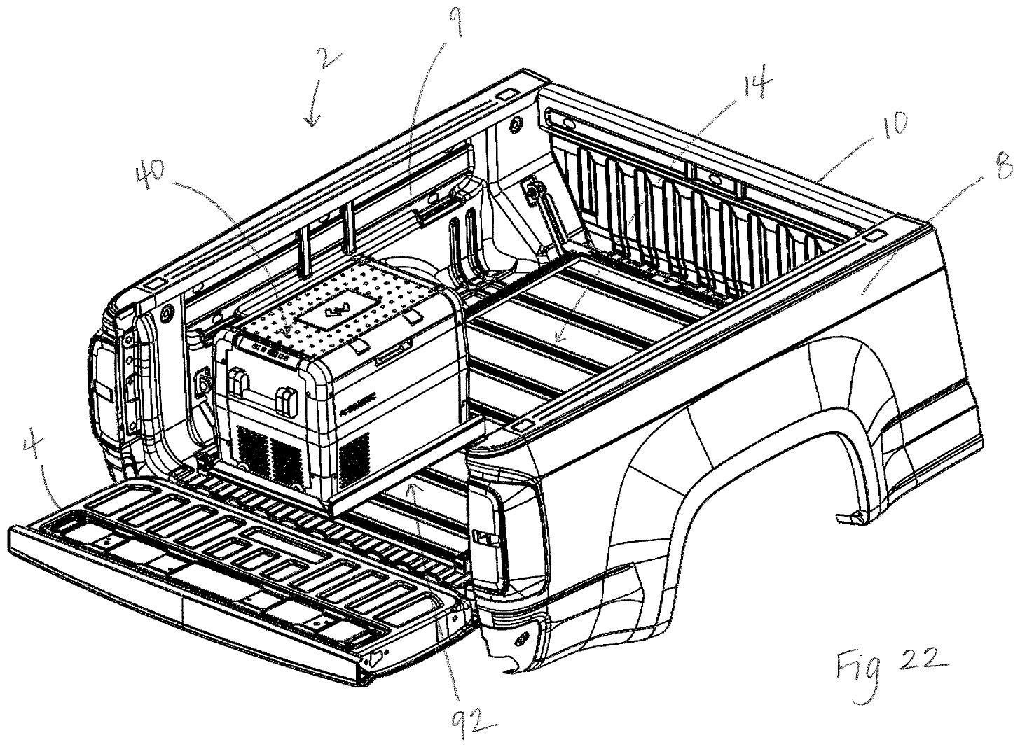

Illustratively, accessory track 32 may include a track channel 34 open at the top of accessory track deck 14. One or more rails 42 and/or 44 (see FIGS. 4, 5, and 6), inside track 32, may be used to secure a nut/slider 38, trolley, stud, or other connecting structure or attachment point that may be either movable along or placed at a particular location in track channel 34 and on at least one rail 42 and/or 44 so that accessories 40 can be attached to that connecting structure or attachment point in accessory track 32. For example, a toolbox, container, partition, power tool, or other structure may be attached to one or more connecting structures attached to one or more accessory tracks 32. These accessory tracks 32 may be periodically spaced apart along the deck with planks 30 fitted in between. Any number of such accessory tracks 32 may run from side to side, front to back (see, FIGS. 20 and 21), a combination of both, or any transverse angle, with respect to tailgate end 26 of cargo box 2.

In another illustrative embodiment, accessory track deck 14 may be attached to cargo box 2 via brackets rather than being part of a slide-out mechanism. When attached to cargo box 2, brackets may be employed to attach to newly formed attachment points on cargo box 2 or to existing attachment points already installed on cargo box 2. For example, in an illustrative embodiment, a bracket may be attached to the deck that attaches to footman loops or other attachment points on the inside sidewalls of cargo box 2. Other brackets may attach to other predesignated attachment points on bed floor 12 or sidewalls 8 and/or 9 of cargo box 2. In some embodiments, a bracket may be located on each side of accessory track deck 14 to attach to predesignated attachment points. An alternate or additional bracket may extend the width of accessory track deck 14 and connect to designated attachment points on each side of cargo box floor 12 or on each side of the inner sidewalls of cargo box 2 depending on the construction of cargo box 2. How the brackets will attach to cargo box 2 is dependent on the type of attachment point(s) on cargo box 2, sidewall 8 or 9, or bed floor 12.

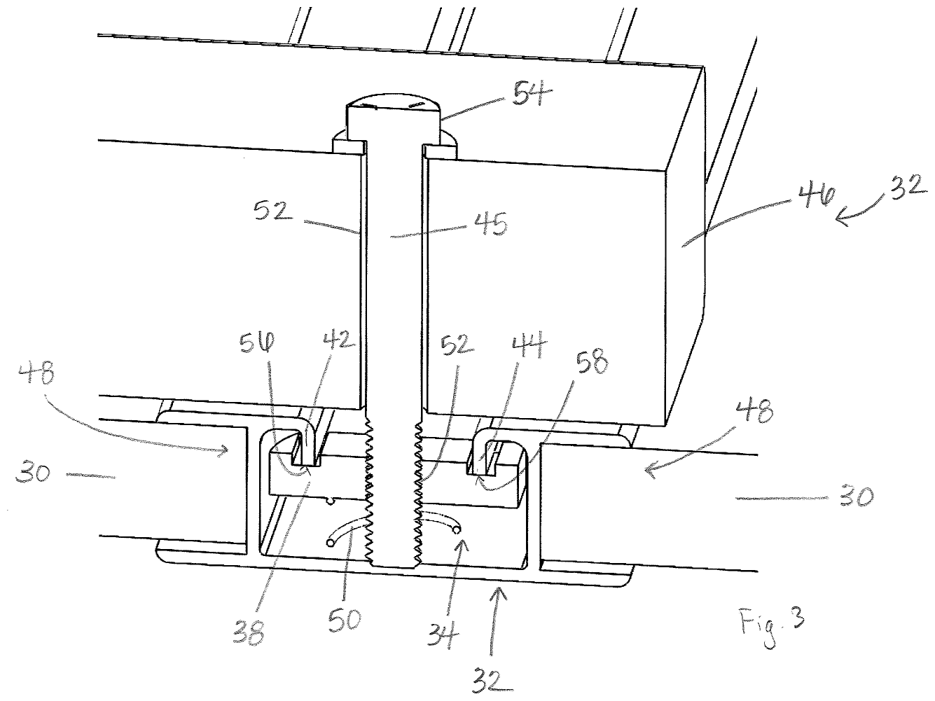

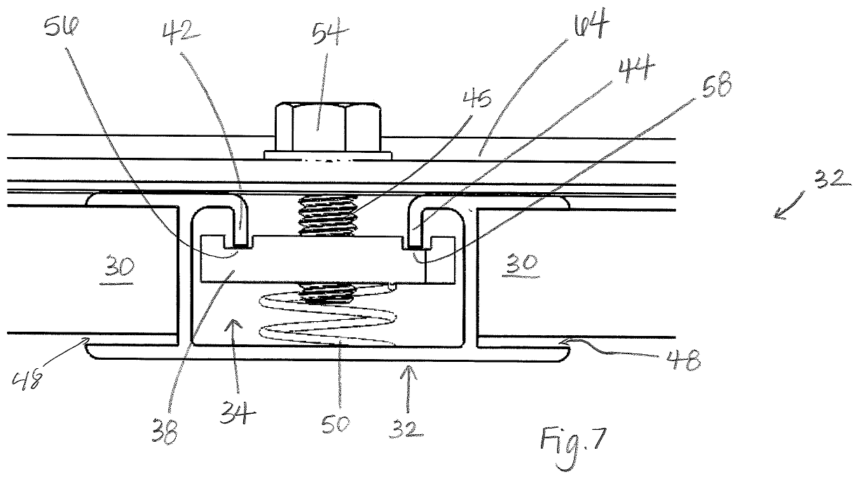

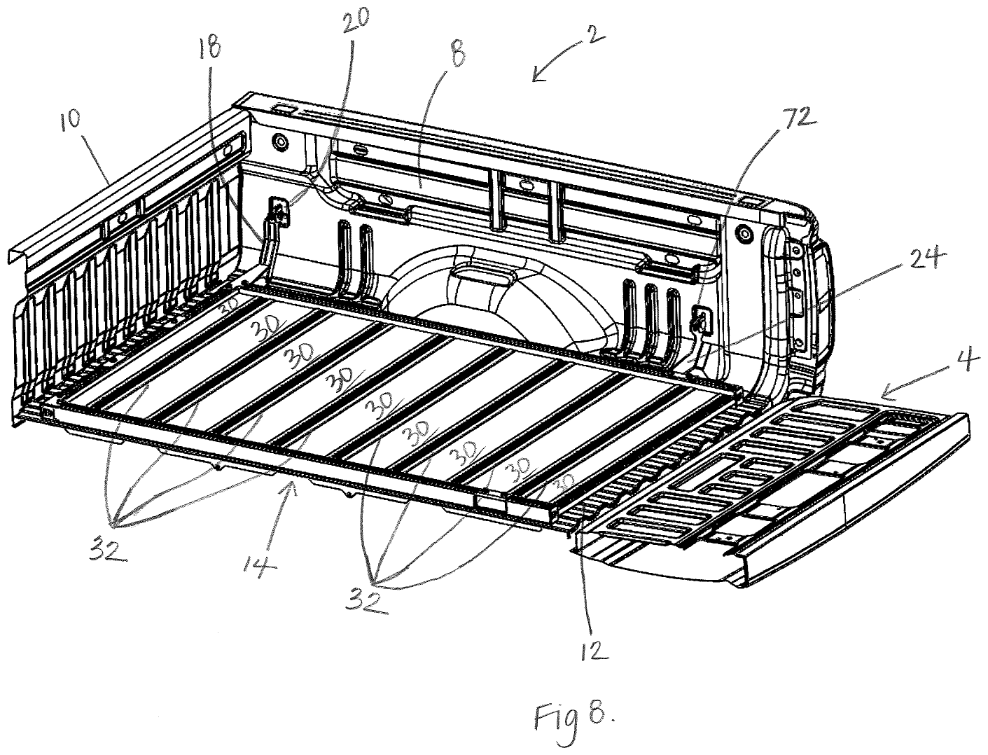

In illustrative embodiments, accessory track 32 may include opposing rails 42 and 44 located in the track channel 34 (see, also, FIG. 3). One or more accessory nut/sliders 38 may be fitted within track channel 34 and engage the rails 42 and 44 at any location along the longitudinal extent of accessory track 32 to create any number of attachment point locations. A fastener or bolt 45 (see, FIG. 7) or other fastening structure may engage the nut/slider 38 to secure to same. An accessory such as a toolbox, block, container, machine, or other structure, may be attached to bolt 45, which is attached to accessory nut/slider 38. Employing multiple accessory nuts/sliders 38 in multiple accessory tracks 32 provide a multitude of attachment point options and locations on accessory track deck 14 to secure any number and variety of accessories thereto.

In another embodiment, an accessory stud may be fitted into accessory track 32 and engage the rails therein. The post portion of the accessory stud may extend from accessory track 32 to provide a structure that accessories may attach to. For example, a plurality of accessory studs may be placed in one accessory track 32 and spaced apart from each other while a second pair of accessory studs are placed in a separate accessory track and spaced apart as well. A box having holes disposed in its bottom may be dimensioned the same as the spacing between the pairs of studs so the box can be placed on accessory track deck 14 with an accessory stud extending through each of the holes. A nut, wingnut, knob, snap ring, cap, or other like structure may be secured to the post of the accessory stud to secure the box to the deck. Because of the versatility of accessory track deck 14, if an accessory is no longer needed to be secured to accessory track deck 14 at a particular location, the accessory can be removed, as well as the accessory studs, to allow for a different configuration of accessory nuts, studs, or other like structures to be coupled to one or more accessory tracks to secure a different accessory.

As further shown in FIG. 1, accessory track deck 14 is composed of a series of alternating planks 30 and accessory tracks 32 extending there-along. In this illustrative embodiment, accessory tracks 32 extend laterally from side to side. In other embodiments, accessory tracks 32 may run front to rear (see, also, FIGS. 20 and 21). The plurality of accessory tracks 32, such as shown herein, provide a versatile flooring structure that can support any variety of items while at the same time be able to secure items to the deck at almost any location thereon. Accessories 40 such as toolboxes, containers, tools, tanks, partitions, or almost anything else can be secured to one or more attachment points on one or more accessory tracks 32. In the illustrated embodiment, blocks 46 are secured to multiple accessory tracks 32 and a miter saw attached to blocks 46.

A similar perspective view of cargo box 2, like that shown in FIG. 1, is also shown in FIG. 2. Here, however, accessory track deck 14 is moved outward in direction 13 from cargo box 2 to an extended position. Contrasting this view of accessory track deck 14 from that in FIG. 1, demonstrates how the attached accessory, in this case the miter saw, can be used at tailgate end 26 of cargo box 2, but then slid to a retracted stowed position within cargo box 2. As shown in FIGS. 1 and 2, with the accessory tracks spaced along accessory track deck 14, the miter saw maybe be placed almost anywhere on the deck convenient for use and storage. The miter saw will remain in its secured position via the accessory tracks and only accessory track deck 14 needs to be moved to and from cargo box 2.

A detail perspective view of a portion of accessory track deck 14, with an illustrative block 46 secured to the accessory track 32, is shown in FIG. 3. This view demonstrates how an accessory 40 may be secured to accessory track deck 14. Here, accessory track 32 includes a track channel 34 extending longitudinally along the length of accessory track 32. Spaced apart illustrative downturned rails 42 and 44, as shown, are located within track channel 34. Plank channels 48 on either side of accessory track 32 receive planks 30, as shown, to create the alternating accessory track/plank deck flooring of accessory track deck 14.

Nut/slider 38 may be used to engage the rail along any portion of accessory track 32 to create an attachment point for other structures. In this case, a fastener 45 is inserted into a nut bore 52 in nut/slider 38 to secure block 46 thereto. Illustratively, nut/slider 38 may be spring biased by a spring 50 against rails 42 and 44 to assist in securing nut/slider 38 at that particular location along accessory track 14. It is appreciated that rail channels 56 and 58 in nut/slider 38 may be employed as a positive stop for nut/slider 38 at a particular location on accessory track 32 or, alternatively, may be a bearing surface to allow nut/slider 38 to move along accessory track 32 to any desired location. It is further appreciated that because nut/slider 38 includes an illustrative threaded bore 52, a fastener or bolt 45 of any appropriate type may be secured to that threaded bore 52 to secure a desired accessory 40 or other structure. In the illustrated case here, with fastener 45 securing block 46 to nut/slider 38, fastener head 54 may alternatively be a knob or other like structure that could be hand tightened or loosened to secure or release block 46 (or any other accessory) to or from nut/slider 38 and, thus, accessory track 32.

Perspective detail views of a portion of accessory track deck 14 are shown in FIGS. 4, 5, and 6. These are progression views that demonstrate how an illustrative nut/slider 38 is inserted into track channel 34 of accessory track 32 to provide an attachment point therein. As shown in FIG. 4, a nut/slider 38, having opposed rail channels 56 and 58 and an illustrative nut bore 52 positioned therebetween, engages spring 50 to provide an upward bias against nut/slider 38 when in track channel 34. Nut/slider 38 is rectangularly-shaped and positioned longways so it can fit within track channel 34, between rails 42 and 44, as shown in FIG. 5. Also shown in this view, is nut/slider 38 positioned in track channel 34 longways and moved below rails 42 and 44 as indicated by downward force 60. Once nut/slider 38 is lower than the bottoms of rails 42 and 44, nut/slider 38 may be rotated 62, as indicated in this view, so that rail channels 56 and 58 may engage rails 42 and 44, respectively, as shown in FIG. 6. Because nut/slider 38 is spring-loaded, downward force 60 is required just enough to clear the bottom of rails 42 and 44. Once this is accomplished, along with nut/slider 38 rotated 62, releasing downward force 60, will cause the spring bias to move nut/slider 38 upward, opposite downward force 60 so rail channels 56 and 58 of nut/slider 38 engage rails 42 and 44, respectively, also shown in FIG. 6. The result is an attachment point at this location along accessory track 32. Nut bore 52 may be used to receive fasteners 45 for attaching accessories at this position on accessory track 32. By duplicating this process at another location on the same or other accessory tracks 32, accessories of any variety of shape or size may be secured to accessory track deck 14.

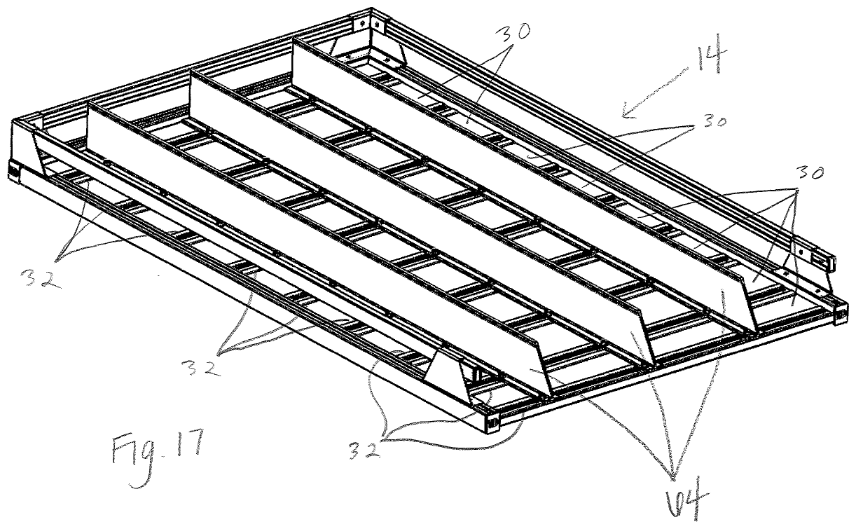

A side detail view of a portion of accessory track deck 14 is shown in FIG. 7. This view illustratively demonstrates how nut/slider 38 is positioned so its rail channels 56 and 58 are fitted in rails 42 and 44 of accessory track 32 with spring 50 biasing upward to help maintain securement between rails 42 and 44 and nut/slider 38. Also shown is a fastener 45 disposed through nut/slider 38, thereby securing an accessory 40 to this position of accessory track deck 14. In this illustrative embodiment, a partition 64 (see, also, FIGS. 16-19) is the illustrative structure secured to accessory track deck 14. Other structures, however, can be alternatively secured. Also shown herein are planks 30 fitted into plank channels 48. It is appreciated that by alternating accessory tracks 32 and planks 30 in any fashion, or as shown here, the flooring of accessory track deck 14 may be created. It is further appreciated that any number of accessory tracks 32 may be employed at any desired location on accessory track deck 14.

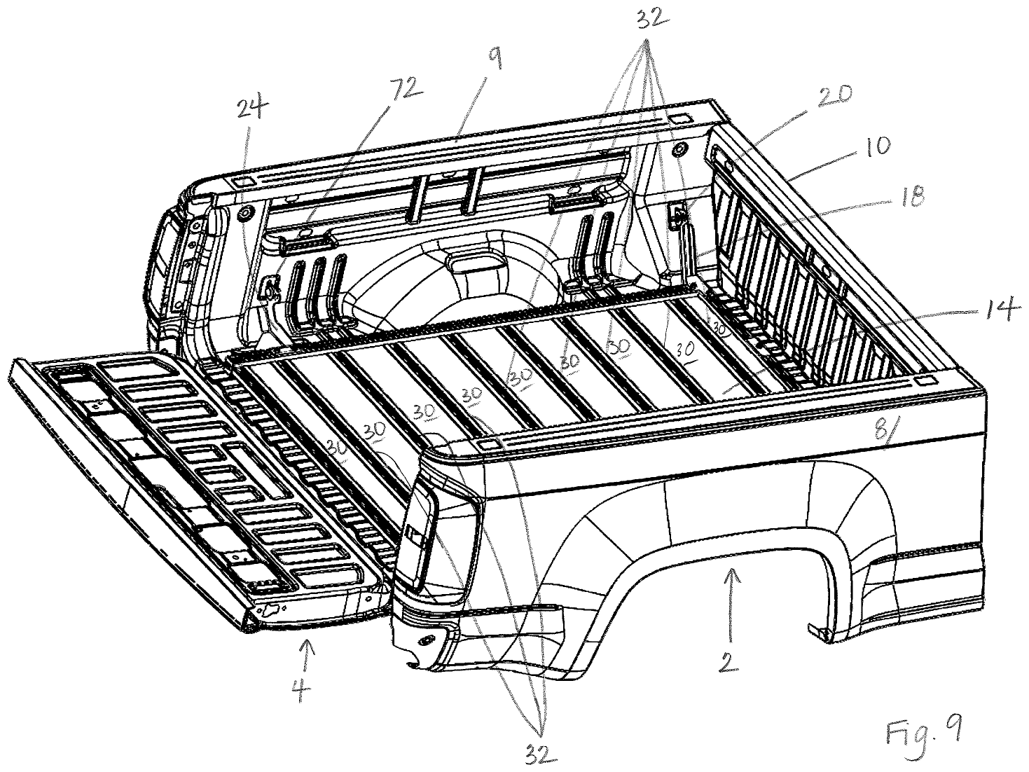

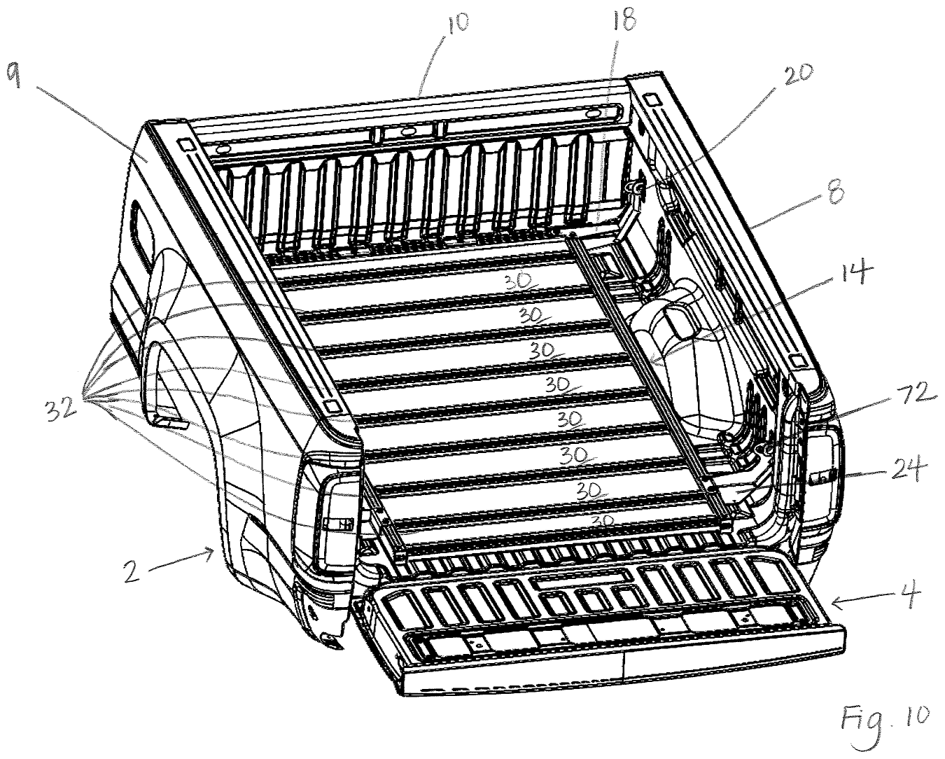

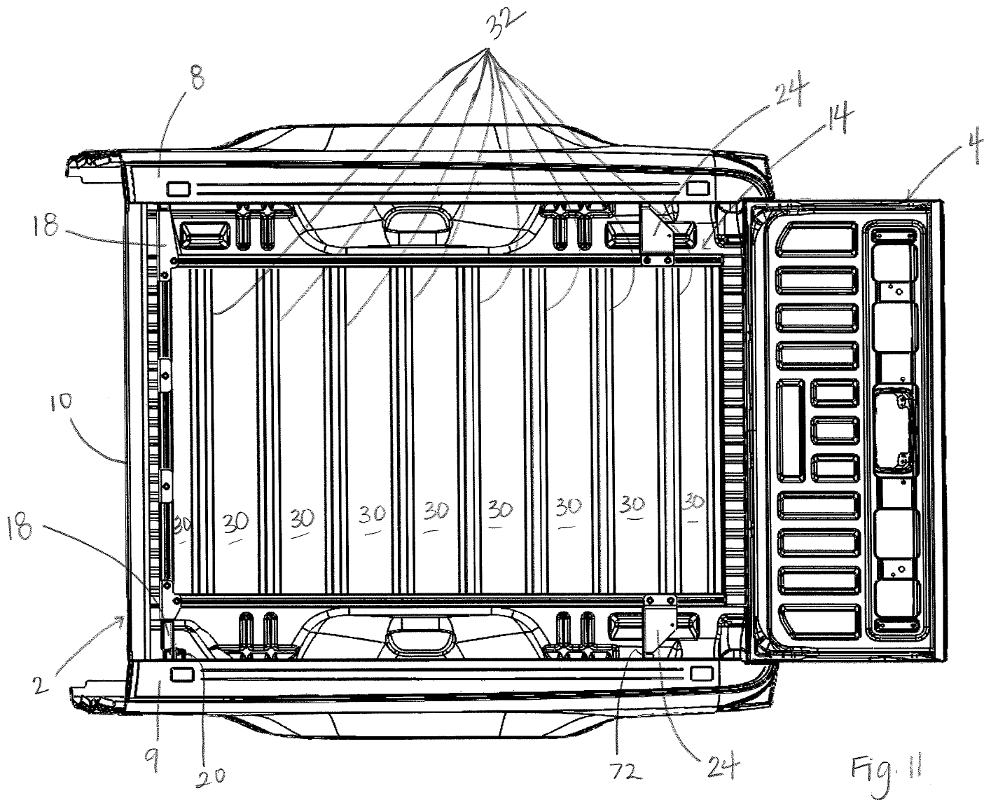

Another illustrative embodiment of the present disclosure is shown in FIGS. 8 through 15. This embodiment provides an accessory track deck 14 for use on bed floor 12 of cargo box 2 similar to that shown in FIGS. 1 and 2. However, in this embodiment, accessory track deck 14 is not part of a movable bedslide assembly that extends in direction 13 and retracts in direction 11 from and to cargo box 2. Instead, this accessory track deck 14 is secured to cargo box 2 and provides attachment locations along accessory tracks 32 to secure accessories thereon.

The perspective views of cargo box 2, shown in FIGS. 8, 9, and 10, depict accessory track deck 14 with alternating accessory tracks and planks secured to cargo box 2. A rear bedslide bracket 18, located adjacent bulkhead end 68 of cargo box 2, is secured to rear attachment points 20 located on each sidewall 8 and 9 of cargo box 2. A side bracket 24, located further towards the front of accessory track deck 14, toward tailgate end 26 of cargo box 2, is likewise attached to an attachment point 72 on each of cargo box 2 sidewalls 8 and 9 as well. As discussed with respect to the bedslide embodiment, accessory track deck 14 herein, and particularly its brackets, may use the preinstalled attachment points already existing on cargo box 2 sidewalls 8 and 9, depending on the make and model of the pickup truck. In this case, because existing attachment points 20 and 72 are located on cargo box 2 sidewalls 8 and 9, rear bedslide bracket 18 and side brackets 24 extend laterally to those attachment points 20 and 72, respectively (see, also, FIGS. 12, 13, 14, and 15). It is appreciated that side brackets 24 and rear bedslide brackets 18 may be used to secure accessory track deck 14 to cargo box 2 at other attachment points, either on sidewalls 8 and 9 or on bed floor 12. In either case, however, accessory track deck 14 provides a plurality of accessory tracks 32 available to receive nuts, sliders, studs, rollers, or other secure structures that can fit into track channel 34 at any particular location thereon and be available as attachment points to secure another structure and hold it in place on accessory track deck 14 in cargo box 2.

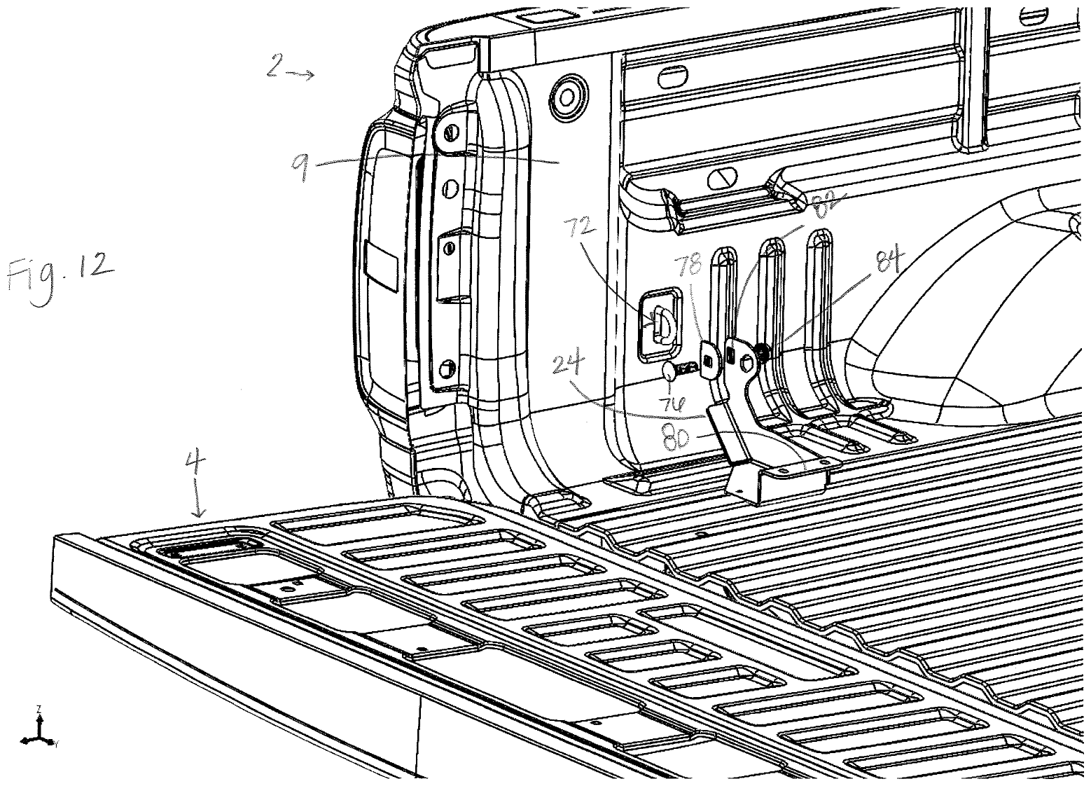

A top view of a cargo box 2, with an accessory track deck 14 installed therein, is shown in FIG. 11. This view better illustrates how the brackets 18 and 24, for accessory track deck 14, secure to same and extend therefrom to mate with attachment points on cargo box 2. As shown, bedslide bracket 18, located toward the rear of accessory track deck 14, extends outwardly therefrom to attach to the attachment points 20 on sidewalls 8 and 9 (see, also, FIGS. 8, 9, and 10). Likewise, side brackets 24 extend from opposing sides of accessory track deck 14 to similarly secure to attachment points 72 on sidewalls 8 and 9. It is also apparent from this view how the accessory tracks extend laterally between cargo box 2 sidewalls 8 and 9. It is appreciated that, in other embodiments, accessory tracks 32 may extend longitudinally between bulkhead 10 and tailgate 4 (see, FIGS. 20 and 21). Having these accessory tracks 32 so configured, provides a broad range of potential attachment points on the deck available to secure any variety of accessories.

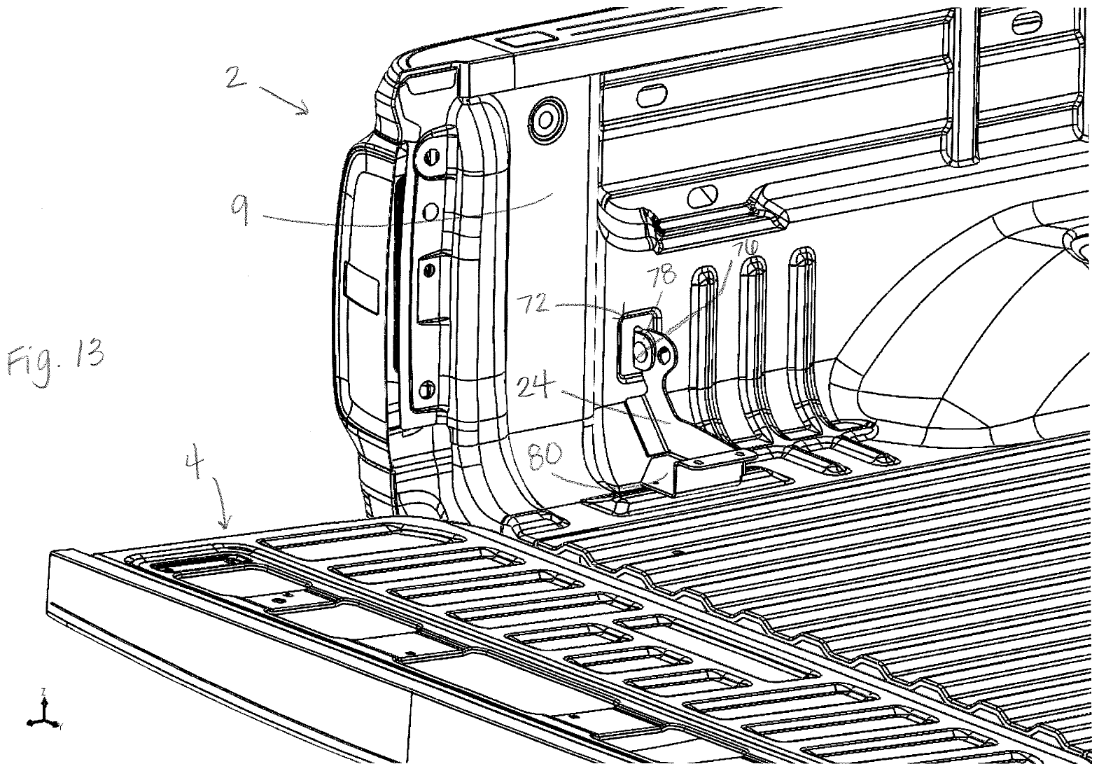

Perspective detail views of a portion of cargo box 2 are shown in FIGS. 12 and 13. These views, in particular, depict how a side bracket 24, which attaches to the side of accessory track deck 14, also attaches to an attachment point 72 on sidewall 9 of cargo box 2. The view shown in FIG. 12 is side bracket 24 with its fastener 76 and plate 78 in an exploded condition. Also shown is attachment point 72, which is illustratively a footman loop attached to sidewall 9 of cargo box 2 and extending inwardly therefrom. As shown in FIG. 12, one end of bracket 24 includes a flange 80 that can be attached to accessory track deck 14. The other end of side bracket 24 may include a bore 82 that can receive fastener 76 that is disposed through plate 78, footman loop 72, side bracket 24, and then secured with a nut 84 on the opposing side of the side bracket 24.

As shown in FIG. 13, fastener 76 secures the footman loop of attachment point 72 on sidewall 9 of cargo box 2 to side bracket 24. This ensures accessory track deck 14 or bedslide 28 will be secured to cargo box 2. It is appreciated that accessory track deck 14 is omitted from these views for demonstrative purposes to show rear bedslide bracket 18 in better detail.

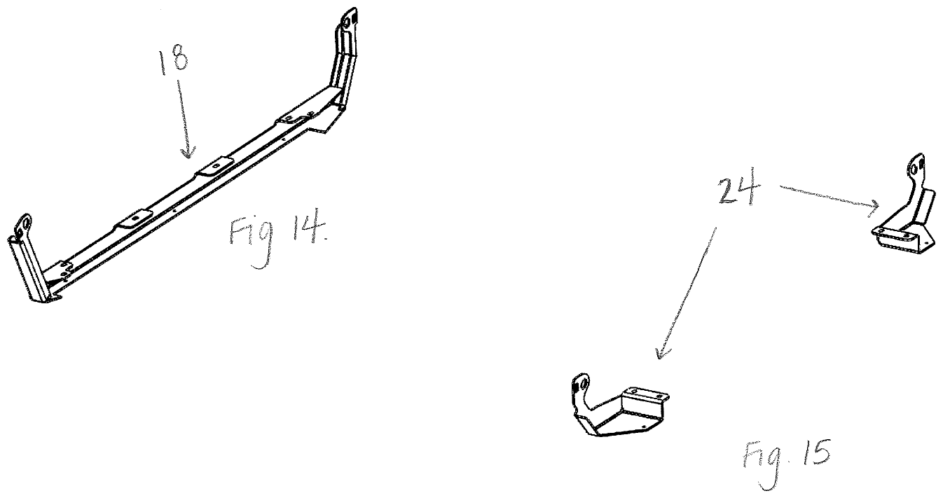

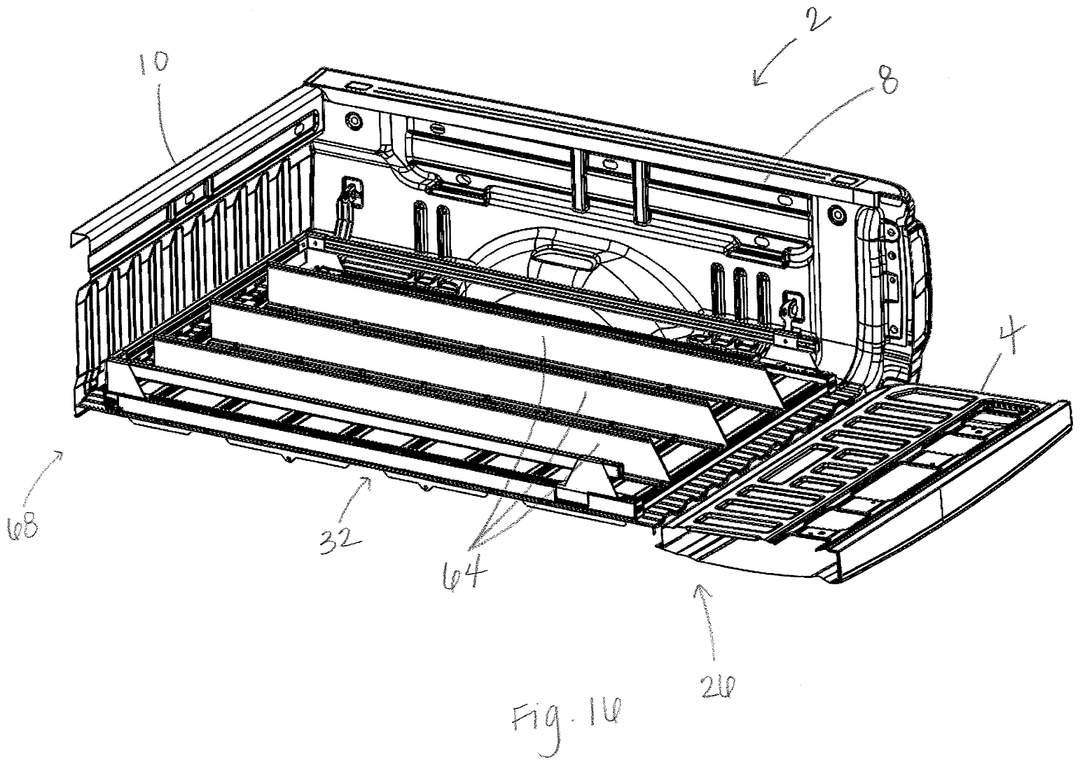

Perspective views of rear bedslide bracket 18 and side brackets 24 are shown in FIGS. 14 and 15, respectively. As shown in FIG. 14, rear bedslide bracket 18 is illustratively configured to attach to the rear of accessory track deck 14 or bedslide 28 and then extend outward from its sides to secure to attachment points 20 on sidewalls 8 and 9 of cargo box 2 similar to that shown in FIGS. 12 and 13. In this way, accessory track deck 14 may be secured to cargo box 2 without having to create attachment points on cargo box 2 itself. Rather, rear bedslide bracket 18 employs previously existing attachment points 20 and 72 on cargo box sidewalls 8 and 9. Similarly, side brackets 24 shown in FIG. 15 attaches to opposing sides of accessory track deck 14 and extending therefrom, again, secures to attachment points 72 already existing on cargo box sidewalls 8 and 9, as shown in FIGS. 12 and 13.

Another illustrative embodiment of the present disclosure demonstrates further utility of accessory track deck 14. The views in FIGS. 16, 17, 18, and 19 depict illustrative partitions 64 that can be secured to accessory track deck 14 by securing them to a series of nuts/sliders 38 positioned in successive accessory tracks 32. The perspective view of cargo box 2 shown in FIG. 16 includes an accessory track deck 14 installed therein as demonstrated in previous embodiments. Here, partitions 64 are illustratively spaced apart from each other and run from bulkhead end 68 to tailgate end 26 on accessory track deck 14. Because these partitions 64 are secured to accessory tracks 32, they will not move when other accessories or items are placed between them. Also, although these partitions 64 are secured to accessory track deck 14 as shown, it is appreciated that they may likewise be employed on accessory track deck 14 of a bedslide 28, such as that shown in FIGS. 1 and 2, for example.

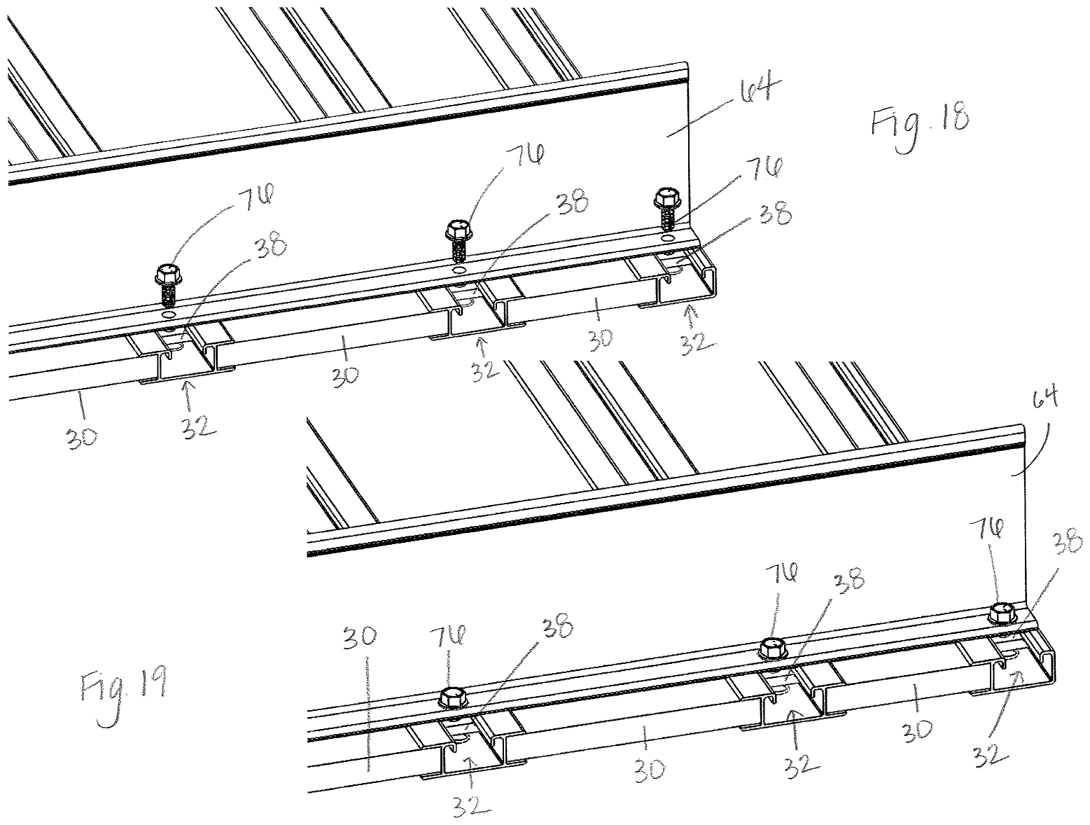

The isolated view of accessory track deck 14 shown in FIG. 17, with the partitions secured thereon, demonstrates the versatility of having the track channels located in the deck. In contrast to the miter saw secured to the deck tracks in FIGS. 1 and 2, accessory track deck 14, shown in FIG. 17, may be reconfigured as needed to secure partitions 64 to accessory track deck 14. These examples are but just two of any variety of accessories that can be attached to attachment points in accessory tracks 32 on accessory track deck 14.

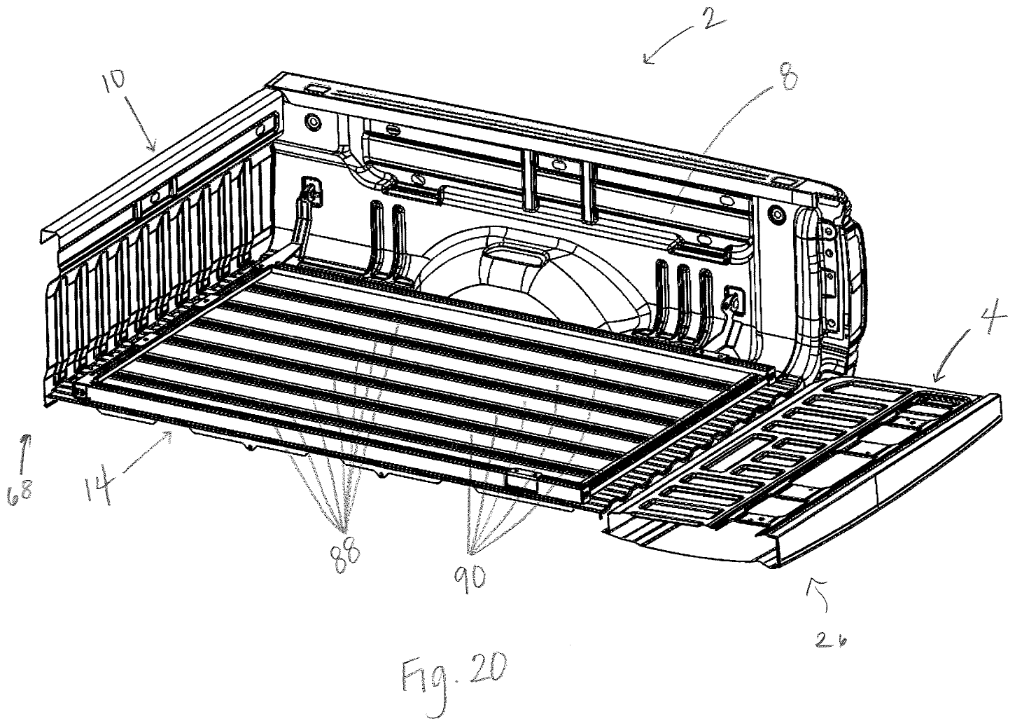

Perspective detail views of a portion of accessory track deck 14 are shown in FIGS. 18 and 19. These progression views demonstrate how a partition 64 (or other structure for that matter) may be attached to the attachment points on accessory tracks 32. In FIG. 18, for example, fasteners 86 (like fastener or bolt 45) are shown extending through the partition to each engage a nut/slider 38 of the type like that shown in FIGS. 3 through 7.

In FIG. 19, fasteners 86 are shown secured to each nut/slider 38, securing the partition 64 at that location on accessory track deck 14. It is appreciated that nut/slider 38 shown herein, with a nut bore 52 disposed therethrough, is illustrative. Alternatively, a stud/slider could be used, which is similar to nut/slider 38 except having a fastener or post extending upward from the structure rather than a nut bore 52 disposed therethrough. The fastener or post may then be secured to partition 64 (or any other structure for that matter) and be threaded to receive a nut or other securing structure. It will be appreciated by the skilled artisan upon reading this disclosure that other structures may be employed in place of the nut/slider so long as it can be retained in the accessory track like that of the nut/slider or via other means. The objective is to create an attachment point for accessories of any variety that may be secured to accessory track deck 14. Nut/slider 38 may even, alternatively, include one or more footman loops like the footman loop of attachment point 72 shown attached to sidewall 9 of cargo box 2. Footman loops installed on nut/sliders 38, in place of the nut bore, may be used as tie down points for straps or hooks.

Another illustrative embodiment of the present disclosure provides an accessory track deck 14 that includes longitudinally-extending accessory tracks 88 as opposed to laterally-extending accessory tracks 32. The views depicted include an accessory track deck 14 secured to bed floor 12 of a cargo box 2 in FIG. 20 and an isolated accessory track deck 14 in FIG. 21. As shown in both views, accessory track deck 14 includes longitudinally extending accessory tracks 88 alternating with longitudinally extending planks 90 to form the floor or deck. Comparing these views with those of accessory track deck 14 from FIGS. 8 through 11, for example, it is appreciated how the different orientations of the accessory tracks may provide different attachment point configurations on the deck. Additionally, the disclosure is not limited to only regularly spaced apart accessory tracks running laterally or longitudinally. For example, it is contemplated to be within this disclosure to employ only one accessory track, or a plurality of accessory tracks that are not necessarily regularly spaced apart or running laterally or longitudinally. For example, an accessory track may be placed in one or more corners of the deck or just one or two accessory tracks fitted at isolated locations in the deck. Alternatively, the accessory tracks may intersect each other, if desired, to create particular attachment point or track configurations.

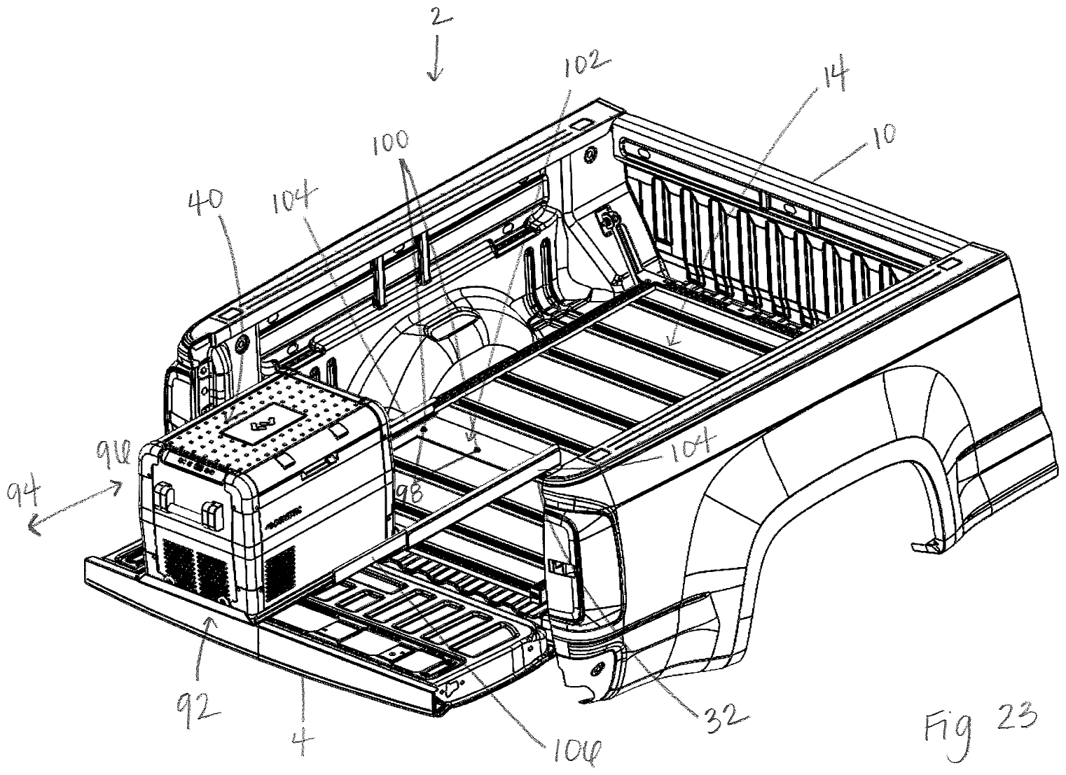

Another illustrative embodiment of the present disclosure includes an accessory slide-out 92 attached to attachment points on accessory track deck 14. A perspective view of a cargo box 2, with an accessory track deck 14 installed thereon, of the type described in prior embodiments, is shown in FIG. 22. An accessory slide-out 92 is shown secured to one or more accessory tracks 32 on accessory track deck 14 to hold an accessory 40 and move it between extended and retracted positions 94 and 96, respectively, with respect to cargo box 2. In this example, a generator is attached to the accessory slide-out.

Another perspective view of cargo box 2 from FIG. 22 is shown in FIG. 23. In this view, however, the generator is extended on accessory slide-out 92 over tailgate 4 to a use position. Illustratively, fasteners 98 at attachment points 100 on accessory slide-out bracket 102 secure slide-out 92 to accessory track deck 14. Longitudinally extending slide-out tracks 104 on slide-out bracket 102 allow rails or glides 106 to extend in direction 94 and retract in direction 96 with respect to tracks 104 and, thus, accessory track deck 14. Illustratively, these can be under mount or side mount extension slides or glides that run along and extend from the slide-out tracks. Glides 106 can be coupled to a tray, bracket(s), or other like structure(s) that can support an accessory. Depending on the size of accessory slide-out 92, its accessory slide out bracket 102 may be secured to one or more accessory tracks 32 as needed. It is appreciated that the attachment points used for accessory slide out bracket 102 may include the nut/slider as described with the previous embodiments, a stud that can fit onto the bracket and secured with the nut, or other like fastening means that can be held in the accessory track and secure to accessory slide out bracket 102.

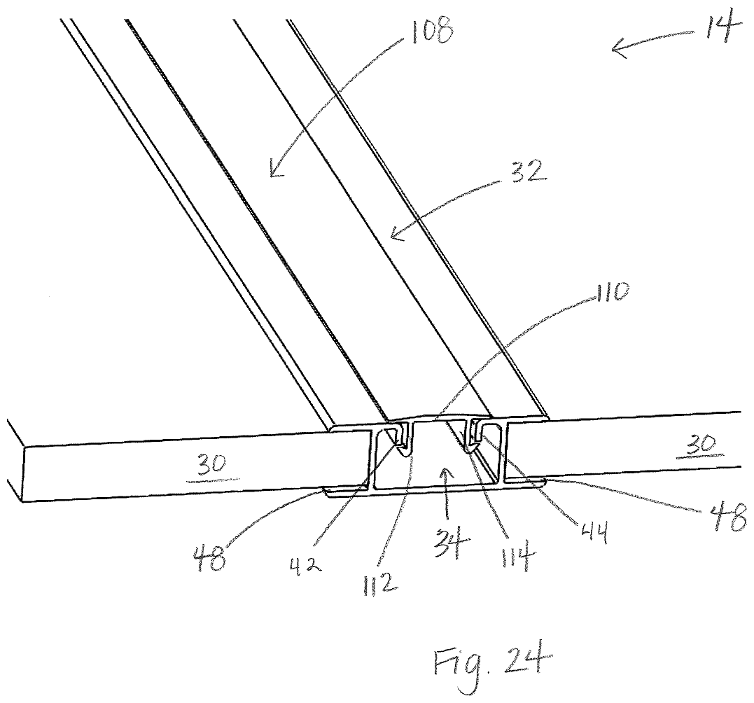

Another illustrative embodiment of the present disclosure provides an accessory track cap 108 that can be used to cover the track channel portion 34 of accessory track 32. A perspective detail view of a portion of an accessory track deck 14 is shown in FIG. 24. In this view, an accessory track 32 is longitudinally extending along accessory track deck 14, bounded by planks 30 on each side, similar to the previous embodiments disclosed herein. As shown in FIG. 24, however, an accessory track cap 108 is positioned over track channel 34 to provide a top surface for accessory track 32, rather, in contrast to, an exposed track channel 34. This can be useful when it is desired not to have an exposed track channel 34 on the accessory track deck 14. As shown herein, accessory track cap 108 includes a cover portion 110 with downwardly depending hooked legs 112 and 114 that engage the ends of rails 42 and 44, respectively, on accessory track 32. Hooked legs 112 and 114 secure accessory track cap 108 to accessory track 32. It is appreciated that in some embodiments, accessory track cap 108 may be made of a flexible material, such as a plastic, to allow hooked legs 112 and 114 to flex some amount to enable them to be attached to and removed from rails 42 and 44, respectively.

Corresponding reference characters indicate corresponding parts throughout the several views. The exemplification set out herein illustrates embodiments of the disclosure, and such exemplification is not to be construed as limiting the scope of the disclosure in any manner. Although the present disclosure has been described with reference to particular means, materials and embodiments from the foregoing description, one skilled in the art can easily ascertain the essential characteristics of the disclosure and various changes and modifications may be made to adapt the various uses and characteristics without departing from the spirit and scope of the disclosure.

What is claimed:

1. An accessory track deck for use on a truck cargo box, the accessory track deck comprising:
a deck assembly that includes:
at least one longitudinally extending plank;
at least one longitudinally extending accessory track;
wherein the at least one longitudinally extending accessory track includes a longitudinally extending opening, a track channel located adjacent the longitudinally extending opening, a first rail located adjacent one side of the longitudinally extending opening, a second rail located adjacent an opposed side of the longitudinally extending opening, and at least one plank channel that receives a portion of the at least one longitudinally extending plank;
at least one slider that includes a first rail channel and a second rail channel; and
a spring that biases the at least one slider towards the first rail and the second rail of the at least one longitudinally extending accessory track;
wherein the first rail channel of the at least one slider receives and is positionable along the first rail;
wherein the second rail channel of the at least one slider receives and is positionable along the second rail; and
wherein the at least one slider includes an attachment point.

2. The accessory track deck of claim 1, wherein the deck assembly further comprises a plurality of longitudinally extending planks.

3. The accessory track deck of claim 2, wherein the deck assembly further comprises a plurality of longitudinally extending accessory tracks.

4. The accessory track deck of claim 3, wherein each of the plurality of longitudinally extending accessory tracks includes a second plank channel that receives a portion of another longitudinally extending plank of the plurality of longitudinally extending planks.

5. The accessory track deck of claim 1, wherein the at least one slider is a plurality of sliders.

6. The accessory track deck of claim 3, wherein the at least one slider is a plurality of sliders and each of the plurality of sliders is configured to be positionable along one of the plurality of longitudinally extending tracks.

7. The accessory track deck of claim 1, further comprising a bedslide assembly frame attachable to the truck cargo box, wherein the deck assembly is movable relative to the bedslide assembly frame.

8. The accessory track deck of claim 1, further comprising a partition, a portion of which is, attachable to the at least one slider.

9. The accessory track deck of claim 1, wherein the attachment point on the at least one slider is selected from the group consisting of at least one of a knob, a footman loop, a hook, a bolt, a tie down, and post.

10. An accessory track deck for use on a truck cargo box, the accessory track deck comprising:
a deck assembly that includes:
at least one plank; and
at least one accessory track;
wherein the at least one accessory track includes an opening, a track channel located adjacent the opening, at least one rail located adjacent one side of the opening.

11. The accessory track deck of claim 10, wherein the at least one accessory track includes a second rail located adjacent an opposed side of the opening.

12. The accessory track deck of claim 10, wherein the at least one accessory track includes at least one plank channel that receives a portion of the at least one plank.

13. The accessory track deck of claim 11, further comprising at least one slider that includes at least one rail channel, and a spring that biases the at least one slider towards the at least one rail of the accessory track, wherein the at least one rail channel of the at least one slider receives and is positionable along the at least one rail.

14. The accessory track deck of claim 13, wherein the at least one slider includes an attachment point that is selected from the group consisting of at least one of a knob, a footman loop, a hook, a bolt, a tie down, nut bore, and post.

15. The accessory track deck of claim 10, wherein the at least one accessory track is configured to receive at least one securement structure selected from the group consisting at least one of a nut, a slider, a stud, and a roller, that is movable within the at least one accessory track.

16. The accessory track deck of claim 10, further comprising an accessory track cap that includes at least one downward depending leg positionable within the track channel, and wherein the accessory track cap covers the opening of the at least one accessory track.

17. An accessory track deck for use on a truck cargo box, the accessory track deck comprising:
a deck assembly that includes a plurality of accessory tracks;
wherein each one of the plurality of accessory tracks includes a longitudinally extending opening, a track channel located adjacent the longitudinally extending opening, a first rail located adjacent one side of the longitudinally extending opening, and a second rail located adjacent an opposed side of the longitudinally extending opening.

18. The accessory track deck of claim 17, wherein the deck assembly further includes at least one plank located adjacent at least one of the plurality of accessory tracks, and wherein at least one of the plurality of accessory tracks includes at least one plank channel that receives a portion of the at least one plank.

19. The accessory track deck of claim 17, further comprising at least one slider that includes a first rail channel and a second rail channel, and a spring that biases the at least one slider towards the first rail and the second rail of the longitudinally extending accessory track, wherein the first rail channel of the at least one slider receives and is positionable along the first rail, and wherein the second rail channel of the at least one slider receives and is positionable along the second rail.

20. The accessory track deck of claim 17, wherein the at least one of the plurality of accessory tracks is configured to receive at least one securement structure selected from the group consisting at least one of a nut, a slider, a stud, and a roller, that is movable within the at least one of the plurality of accessory tracks.
